(19) United States
(12) Patent Application Publication
(10) Pub. No.: US 2025/0371216 A1
(43) Pub. Date: Dec. 4, 2025

(54) COMPUTER PROGRAM, INFORMATION PROCESSING METHOD, AND INFORMATION PROCESSING APPARATUS

(71) Applicant: Tokyo Electron Limited, Tokyo (JP)

(72) Inventor: Kaoru SAKO, Sapporo-shi (JP)

(73) Assignee: Tokyo Electron Limited, Tokyo (JP)

(21) Appl. No.: 19/299,820

(22) Filed: Aug. 14, 2025

Related U.S. Application Data
(63) Continuation of application No. PCT/JP2024/004708, filed on Feb. 13, 2024.

(30) Foreign Application Priority Data
Feb. 22, 2023 (JP) 2023-026359

(51) Int. Cl. G06F 30/20; G06T 11/20

(52) U.S. Cl. CPC G06F 30/20; G06T 11/206

(57) ABSTRACT

Provided are a non-transitory computer-readable storage medium, an information processing method, and an information processing apparatus that can obtain reliability of a predicted shape obtained through a shape simulation. The non-transitory computer-readable storage medium executes, via a computer, a method comprising acquiring a first shape feature that characterizes a predicted shape obtained by prediction using a model for simulating processing on a substrate, simulating, using the model, processing according to any recipe on a substrate having any shape, and calculating a second shape feature that characterizes a predicted shape of the substrate at a stage when processing according to each processing step in the any recipe is performed, comparing the second shape feature with the first shape feature to calculate reliability of the predicted shape after each processing step in the any recipe, and outputting a relationship between each processing step and the reliability.

### CROSS-REFERENCE TO RELATED APPLICATIONS

This application is a bypass Continuation Application of International Application No. PCT/JP2024/004708 having an international filing date of Feb. 13, 2024 and designating the United States, the international application being based upon and claiming the benefit of priority under 35 U.S.C. § 119(a) from Japanese Patent Application No. 2023-026359, filed on Feb. 22, 2023, the entire contents of each are incorporated herein by reference.

### TECHNICAL FIELD

The present disclosure relates to a computer program, an information processing method, and an information processing apparatus.

### BACKGROUND

Substrate processing, which involves etching or the like, on a substrate such as a semiconductor wafer is performed according to a recipe that defines processing contents. The recipe is a combination of a plurality of processing steps in a set order, and processing contents of each processing step are set. In related art, a shape simulation is performed using a computer to predict a shape of a substrate obtained by substrate processing. Patent Document 1 discloses an example of shape simulation.

### CITATION LIST

### Patent Documents

Patent Document 1: WO2019/155928

### SUMMARY

An error may occur between a predicted shape obtained by predicting a substrate shape through a shape simulation and an actual substrate shape obtained through actual substrate processing. For example, an error may occur when conditions such as the substrate shape when a model used for performing the shape simulation is created and conditions under which the shape simulation is performed are different from each other. When the error is large, reliability of the predicted shape is low. In the shape simulation, there is a need to know the reliability of the predicted shape.

The disclosure provides a computer program, an information processing method, and an information processing apparatus that can obtain reliability of a predicted shape obtained through a shape simulation.

A computer program according to an aspect of the disclosure causes a computer to execute processing of: acquiring a first shape feature that characterizes a predicted shape obtained by predicting a shape of a processed substrate using a model for simulating processing on a substrate having a predetermined shape according to a predetermined recipe including a predetermined plurality of processing steps, simulating, using the model, processing according to any recipe on a substrate having any shape, and calculating a second shape feature that characterizes a predicted shape of the substrate at a stage when processing according to each processing step in the any recipe is performed, comparing the second shape feature with the first shape feature to calculate reliability of the predicted shape of the substrate at the stage when the processing according to each processing step in the any recipe is performed, and outputting a relationship between the reliability and each processing step in the any recipe.

According to the disclosure, it is possible to provide a computer program, an information processing method, and an information processing apparatus that can obtain reliability of a predicted shape obtained through a shape simulation.

### BRIEF DESCRIPTION OF DRAWINGS

FIG. 1 is a conceptual diagram illustrating an example of contents of a plurality of processing steps.

FIG. 2 is a conceptual diagram illustrating an example of contents of a recipe.

FIG. 3 is a block diagram illustrating an example of an internal configuration of an information processing apparatus.

FIG. 4 is a conceptual diagram illustrating an example of a shape simulation of substrate processing according to a predetermined recipe on a substrate having a predetermined initial shape.

FIG. 5 is a flowchart illustrating an example of a processing procedure of analyzing reliability of a predicted shape executed by the information processing apparatus.

FIG. 6 is a schematic diagram illustrating an example of an index value that can be used as a first shape feature.

FIG. 7 is a conceptual diagram illustrating an example of information processing for acquiring the first shape feature from the predicted shape after each processing step.

FIG. 8 is a conceptual diagram illustrating an example of information processing for acquiring an allowable range for the first shape feature.

FIG. 9 is a graph illustrating an example of a second shape feature.

FIG. 10 is a graph illustrating an example of a comparison result between the second shape feature and the allowable range for the first shape feature.

FIG. 11 is a schematic diagram illustrating an output example of the processing step and the reliability of the predicted shape.

FIG. 12 is a schematic diagram illustrating an example of a comparison between a predicted shape having high reliability and a substrate shape obtained through actual substrate processing.

FIG. 13 is a schematic diagram illustrating an example of a comparison between a predicted shape having low reliability and the substrate shape obtained through actual substrate processing.

### DETAILED DESCRIPTION

Hereinafter, the disclosure will be specifically described with reference to the drawings illustrating an embodiment thereof.

A process for producing a substrate such as a semiconductor wafer, a glass substrate, or a flat panel substrate includes a process of performing processing such as etching or film formation on a substrate. Hereinafter, the processing performed on the substrate will be referred to as substrate processing, and a device for executing the substrate processing will be referred to as a processing device. For example, the processing apparatus is a process chamber, and processes, such as etches the substrate disposed in the process chamber. The processing device processes the substrate according to a predetermined recipe in which processing contents are set. The recipe includes a plurality of processing steps in a set order. Each processing step is a smallest unit of a time series processing procedure for the substrate.

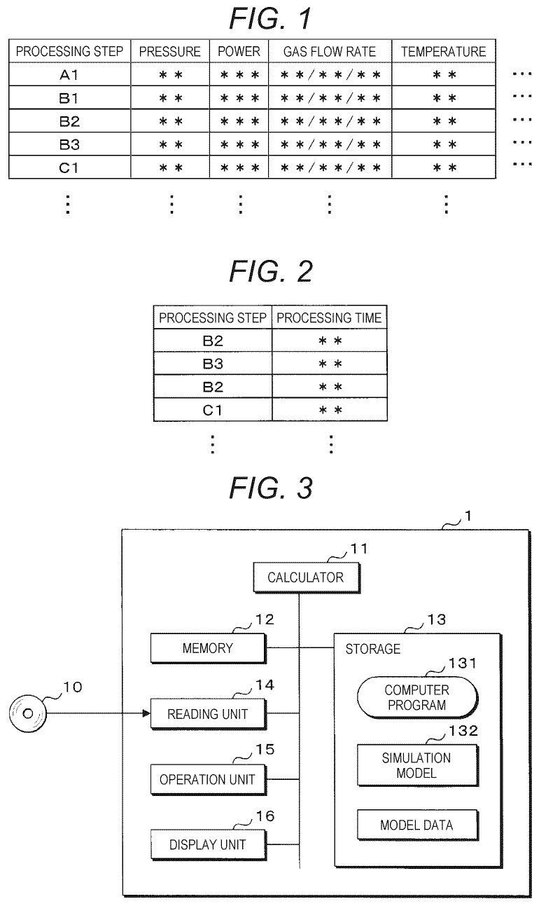

FIG. 1 is a conceptual diagram illustrating an example of contents of a plurality of processing steps. In each processing step, contents of substrate processing executed by the processing apparatus are determined. The contents of the substrate processing include processing conditions. For example, the substrate processing is etching. In the example illustrated in FIG. 1, names A1, B1, and the like are given to the plurality of processing steps, respectively. For example, as the processing contents of each processing step, a pressure in a process chamber, power supplied to the process chamber during etching, flow rates of a plurality of types of gases supplied to the process chamber, and a temperature in the process chamber are determined. In the processing step, processing contents other than the pressure, the power, the gas flow rate, and the temperature may be determined. The processing contents vary for each processing step.

The recipe is formed by combining a plurality of processing steps. FIG. 2 is a conceptual diagram illustrating an example of contents of the recipe. In the recipe, the plurality of processing steps to be executed, an order in which substrate processing is performed according to the processing steps, and a processing time (process time) that is a time during which the substrate processing according to each processing step is continued are determined. In the example illustrated in FIG. 2, the processing steps are indicated by the names, and the processing time of each processing step is associated with the name of the processing step. The names of the processing steps are arranged vertically. An order in which the processing steps are arranged indicates the order in which the substrate processing according to the processing steps is executed. For example, the substrate processing according to each processing step is executed sequentially from top to bottom. A plurality of processing steps included in one recipe may include a plurality of the same processing steps. In the embodiment, a shape simulation is performed to calculate a predicted shape of a substrate obtained through substrate processing according to any recipe, thereby acquiring reliability of the predicted shape.

FIG. 3 is a block diagram illustrating an example of an internal configuration of an information processing apparatus 1. The information processing apparatus 1 executes an information processing method. The information processing apparatus 1 is implemented using a computer such as a personal computer or a server device. The information processing apparatus 1 includes a calculator 11, a memory 12, a storage 13, a reading unit 14, an operation unit 15, and a display unit 16. The calculator 11 is implemented using, for example, a central processing unit (CPU), a graphics processing unit (GPU), or a multi-core CPU. The calculator 11 may also be implemented using a quantum computer. The memory 12 stores temporary data generated along with calculation. The memory 12 is, for example, a random access memory (RAM). The storage 13 is non-volatile, and is, for example, a hard disc or a non-volatile semiconductor memory. The reading unit 14 reads information from a recording medium 10 such as an optical disc or a portable memory. The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are programmed, using one or more programs stored in one or more memories, or otherwise configured to perform the disclosed functionality. Processors and controllers are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

The operation unit 15 receives an input of information such as text by receiving an operation from a user. The operation unit 15 is, for example, a keyboard, a pointing device, or a touch panel. The display unit 16 displays an image. The display unit 16 is, for example, a liquid crystal display or an electroluminescent display (EL display). The operation unit 15 and the display unit 16 may be integrated.

The calculator 11 causes the reading unit 14 to read a computer program (program product) 131 recorded in the recording medium 10, and causes the storage 13 to store the read computer program 131. The calculator 11 executes information processing for implementing functions of the information processing apparatus 1 according to the computer program 131. The computer program 131 may be stored in advance in the storage 13 or may be downloaded from outside the information processing apparatus 1. In this case, the information processing apparatus 1 does not need to be provided with the reading unit 14.

The computer program 131 may be loaded to be executed on a single computer or on a plurality of computers disposed at one site or distributed across a plurality of sites and interconnected by a communication network. That is, the information processing apparatus 1 may be implemented by a plurality of computers, and the computer program 131 may be executed on the plurality of computers connected through the communication network. The information processing apparatus 1 may be implemented using a cloud server.

The information processing apparatus 1 includes a simulation model 132 that performs a shape simulation for predicting a substrate shape obtained by substrate processing. In the shape simulation, the simulation model 132 performs a simulation in which the substrate processing is sequentially executed on a substrate having a specific initial shape according to a plurality of processing steps in a specific recipe. At this time, the simulation model 132 calculates a predicted shape predicted by simulating the substrate shape obtained through the substrate processing according to each processing step at a stage of each processing step. When the substrate includes a plurality of layers such as an amorphous carbon layer (ACL), a SiON layer, and a polymer layer, the simulation model 132 simulates the substrate processing for the plurality of layers. The simulation model 132 includes a computer program for the shape simulation. The computer program for the shape simulation is stored in the storage 13 and included in, for example, the computer program 131.

The simulation model 132 may be a trained model that outputs the predicted shape when the initial shape and the processing step of the substrate are received. In such an aspect, the simulation model 132 is implemented by the calculator 11 executing information processing according to the computer program 131. For example, the simulation model 132 is implemented using a neural network.

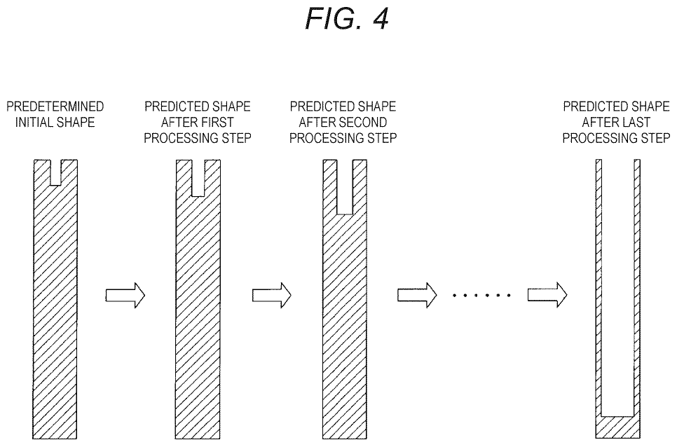

The simulation model 132 is created such that a final predicted shape becomes a predetermined predicted shape when the shape simulation of the substrate processing is performed according to the predetermined recipe on the substrate having the predetermined initial shape. FIG. 4 is a conceptual diagram illustrating an example of the shape simulation of the substrate processing according to the predetermined recipe on the substrate having the predetermined initial shape. The predetermined recipe includes a plurality of processing steps whose order is determined. The simulation model 132 calculates a predicted shape of the substrate obtained through substrate processing performed according to a first processing step on the substrate having the predetermined initial shape. Next, the simulation model 132 calculates a predicted shape of the substrate obtained through substrate processing according to a second processing step on the predicted shape after the first processing step, and calculates predicted shapes after each processing step sequentially. FIG. 4 is a schematic cross-sectional view of a part of the predicted shapes after each processing step. A predicted shape after a last processing step is the final predicted shape.

The simulation model 132 is adjusted in advance such that the final predicted shape becomes the predetermined predicted shape. The predetermined predicted shape is the same as a substrate shape obtained when substrate processing is actually performed according to the predetermined recipe on the substrate having the predetermined initial shape. Therefore, in the shape simulation using the simulation model 132 under conditions of the predetermined initial shape and the predetermined recipe, the predicted shape is accurately calculated. For example, the simulation model 132 performs the shape simulation using a plurality of parameters related to processing conditions. The parameters are adjusted in advance such that the final predicted shape obtained through the shape simulation of the substrate processing according to the predetermined recipe on the substrate having the predetermined initial shape becomes the predetermined predicted shape. For example, the parameters are various coefficients in a computer program for implementing the simulation model 132.

A result of the shape simulation by the simulation model 132 according to the predetermined recipe on the substrate having the predetermined initial shape is stored in the storage 13. More specifically, shape data representing the predicted shapes after the plurality of processing steps in the predetermined recipe is recorded in model data, and the model data is stored in the storage 13.

The information processing apparatus 1 uses the simulation model 132 to perform a shape simulation of calculating a predicted shape obtained through substrate processing according to any recipe on a substrate having any initial shape. The simulation model 132 is created by assuming a plurality of conditions for a process that may be executed in an actual substrate production step. Therefore, the any initial shape and the any recipe that are conditions for performing the shape simulation are different from the predetermined initial shape and the predetermined recipe that are conditions for creating the simulation model 132. Therefore, in the shape simulation using the simulation model 132, an error may occur in the predicted shape. That is, an error may occur between the predicted shape obtained by the shape simulation according to the any initial shape and the any recipe, and a substrate shape obtained by actual substrate processing according to the any recipe on the substrate having the any initial shape. When the error is large, the reliability of the predicted shape obtained by the shape simulation is low.

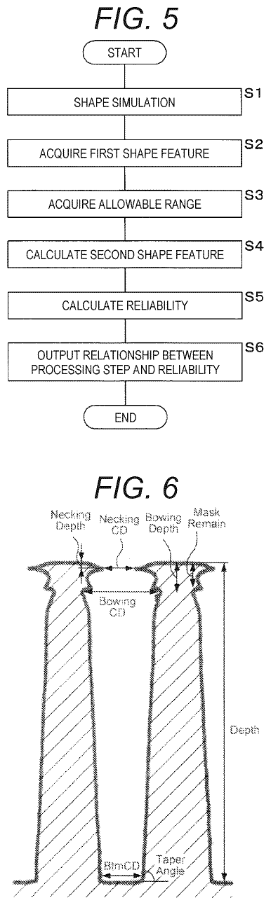

The information processing executed by the information processing apparatus 1 will be described. The information processing apparatus 1 performs the shape simulation to analyze the reliability of the predicted shape. FIG. 5 is a flowchart illustrating an example of a processing procedure of analyzing the reliability of the predicted shape executed by the information processing apparatus 1. Hereinafter, the step of the information processing executed by the information processing apparatus 1 will be abbreviated as S. The information processing apparatus 1 executes the following processing by the calculator 11 executing the information processing according to the computer program 131.

The information processing apparatus 1 uses the simulation model 132 to perform the shape simulation of calculating the predicted shape obtained through the substrate processing according to any recipe on the substrate having any initial shape (S1). For example, the user operates the operation unit 15 to input the any initial shape and the any recipe to the information processing apparatus 1. The any initial shape and the any recipe may be received by the information processing apparatus 1 through an interface (not illustrated). The any initial shape and the any recipe may be stored in advance in the storage 13 and read from the storage 13.

In S1, the calculator 11 executes the shape simulation using the simulation model 132. In the shape simulation, the calculator 11 simulates substrate processing according to a specific recipe on a substrate having a specific initial shape and calculates a predicted shape obtained by predicting a substrate shape obtained through the substrate processing according to each processing step in the recipe. The calculator 11 stores data representing the predicted shape after each processing step in the storage 13.

The information processing apparatus 1 acquires a first shape feature that characterizes the predicted shape obtained through the shape simulation of the substrate processing according to the predetermined recipe on the substrate having the predetermined initial shape (S2). Shape data representing the predicted shape after each processing step in the predetermined recipe is contained in the model data stored in the storage 13. In S2, the calculator 11 acquires one or a plurality of types of first shape features by calculating the one or a plurality of types of first shape features based on the shape data.

As the first shape feature, an index value indicating a size or an angle of a specific portion in the predicted shape of the substrate is used. FIG. 6 is a schematic diagram illustrating an example of the index value that can be used as the first shape feature. FIG. 6 is a schematic cross-sectional view of a portion of the predicted shape of the substrate. In the substrate processing, processing of forming a hole in the substrate is performed, Depth is a depth of the hole, Btm CD is a width of a bottom of the hole, and Taper Angle is a taper angle of a ridge portion between holes. Bowing CD is a width of the hole at a portion where a sidewall of the hole is concave and the width is maximized, and Bowing Depth is a depth to the portion where the width of the hole is maximized. Necking CD is a width of the hole at a portion where the sidewall of the hole is convex and the width is minimized, and Necking Depth is a depth to the portion where the width of the hole is minimized. Mask Remain is a height of a mask left at the substrate during the substrate processing.

The index values illustrated in FIG. 6 are examples, and another index value may be used as the first shape feature. For example, another example of the index value is an aperture ratio obtained by dividing an area of an opening portion opened by forming the hole at a substrate surface by an area of the substrate surface. Another example of the index value is a density state of a wiring pattern formed on the substrate by forming the hole.

The calculator 11 uses one or a plurality of types of index values among the plurality of types of index values described above as the first shape feature. The calculator 11 may use the index value directly as the first shape feature, or may use, as the first shape feature, a value after a predetermined calculation such as multiplying the index value by a predetermined coefficient. Alternatively, the calculator 11 may calculate the first shape feature by performing a predetermined calculation such as addition, subtraction, multiplication, or division on the plurality of types of index values. For example, the calculator 11 may calculate the first shape feature by calculating a weighted average of the plurality of types of index values. A weight of each index value may be different according to a material of each layer of the substrate.

As the first shape feature, a shape descriptor obtained by analyzing the predicted shape may be used. For example, the calculator 11 performs elliptic Fourier analysis on the predicted shape, calculates an elliptic Fourier descriptor, and uses the elliptic Fourier descriptor as the first shape feature. For example, the calculator 11 calculates a Hu moment of the predicted shape and uses the Hu moment as the first shape feature. The calculator 11 may use the shape descriptor directly as the first shape feature, or may use, as the first shape feature, a value after a predetermined calculation is applied to the shape descriptor. The calculator 11 may calculate the first shape feature by performing a calculation on a plurality of types of shape descriptors. Alternatively, the calculator 11 may calculate the first shape feature by performing a predetermined calculation using the index value and the shape descriptor described above. The index value or the shape descriptor appropriately represents characteristics of the predicted shape and enables a comparison with another shape.

The calculator 11 calculates the first shape feature for the predicted shape of the substrate obtained through the substrate processing performed according to each processing step in the predetermined recipe. The calculator 11 also calculates the first shape feature for each of a plurality of locations in the predicted shape. That is, for each of the plurality of processing steps in the predetermined recipe, the calculator 11 acquires a plurality of instances of one or a plurality of types of first shape features.

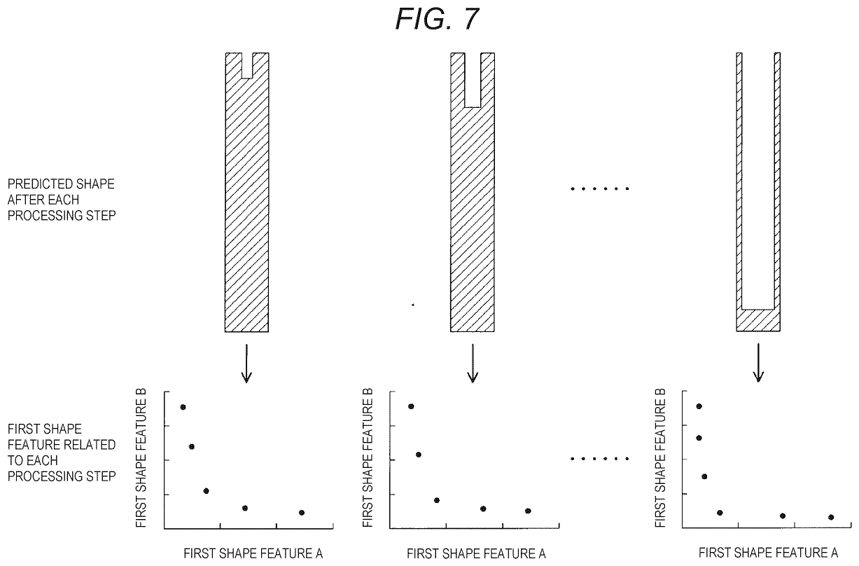

FIG. 7 is a conceptual diagram illustrating an example of information processing for acquiring the first shape feature from the predicted shape after each processing step. FIG. 7 is a schematic cross-sectional view of a part of the predicted shapes after each processing step. In addition, an example will be shown in which two types of first shape features, that is, a first shape feature A and a first shape feature B, are acquired, and the first shape feature is shown by a graph in which a horizontal axis represents the first shape feature A and a vertical axis represents the first shape feature B. The first shape feature is calculated for each of the plurality of processing steps, and a plurality of first shape features of a plurality of types are calculated based on the predicted shape after one processing step. The calculator 11 stores the first shape features acquired for the predicted shapes after the plurality of processing steps in the storage 13. Further, the information processing apparatus 1 acquires the first shape features for each of a plurality of layers in the predicted shape.

The information processing apparatus 1 then acquires an allowable range for the first shape feature (S3). In S3, the calculator 11 determines, for each of the plurality of first shape features acquired in S2, an allowable range that includes each first shape feature, thereby acquiring the allowable range for the first shape feature. For example, for the index value or the shape descriptor described above that is used as the first shape feature, a predetermined allowable range, such as a range where an absolute value of a difference becomes a predetermined value or less, or a range where a ratio of a value change amount becomes a predetermined ratio or less, is determined and stored in advance in the storage 13. The allowable range for each index value or shape descriptor may vary depending on the material of each layer of the substrate. The allowable range for each index value or shape descriptor may be input to the information processing apparatus 1 by the user operating the operation unit 15.

When the index value or the shape descriptor is used directly as the first shape feature, the allowable range determined for the index value or the shape descriptor is determined as the allowable range for the first shape feature. When a value obtained after a predetermined calculation is applied to the index value or the shape descriptor is the first shape feature, the allowable range for the first shape feature is determined by applying the same calculation to the allowable range determined for the index value or the shape descriptor. For example, when the weighted average of the index value or the shape descriptor is the first shape feature, a weighted average of the allowable range determined for the index value or the shape descriptor is the allowable range of the first shape feature.

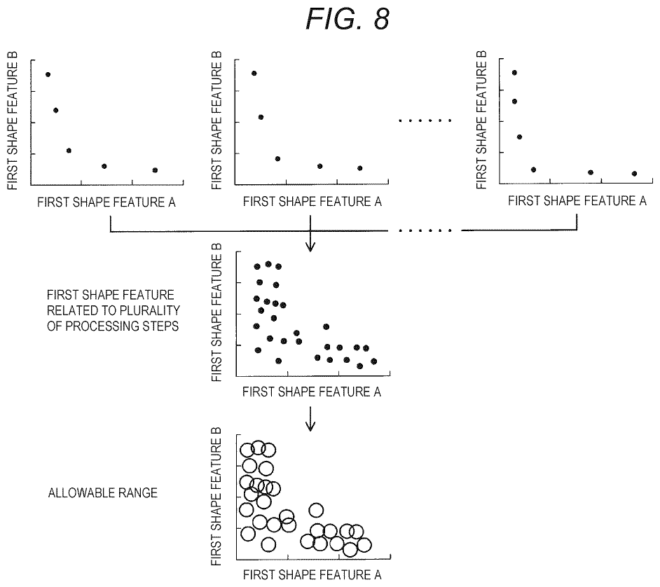

FIG. 8 is a conceptual diagram illustrating an example of information processing for acquiring the allowable range for the first shape feature. A graph similar to that in FIG. 7 represents the first shape feature. The calculator 11 collects the first shape features acquired for the predicted shapes after the plurality of processing steps in S2, thereby acquiring the plurality of first shape features related to the plurality of processing steps. The calculator 11 sets the allowable range for each of the plurality of first shape features to acquire the allowable range that includes the plurality of first shape features. In FIG. 8, the respective first shape features are indicated by dots on the graph, and the allowable range for each first shape feature is indicated by a white circle. The calculator 11 acquires a set of allowable ranges determined for each of the plurality of first shape features, as illustrated in FIG. 8, as the allowable range that includes the plurality of first shape features. The calculator 11 stores the acquired allowable range for the first shape features in the storage 13. Further, the information processing apparatus 1 acquires an allowable value for each first shape feature for each of the plurality of layers in the predicted shape.

The information processing apparatus 1 may calculate the first shape feature and the allowable range in advance and store the same in the storage 13. That is, in steps S2 and S3, the calculator 11 may read the first feature and the allowable range from the storage 13, thereby acquiring the first feature and the allowable range. S2 and S3 may be executed before S1.

The information processing apparatus 1 calculates the second shape feature that characterizes the predicted shape obtained through the shape simulation of the substrate processing according to the any recipe on the substrate having the any initial shape (S4). In S4, the calculator 11 calculates the second shape feature based on the shape data indicating the predicted shape after each processing step obtained through the shape simulation in S1. The calculator 11 calculates, as the second shape feature, the same type of feature as the first shape feature acquired in S2. The calculator 11 also calculates the second shape feature for each of a plurality of processing steps in the any recipe.

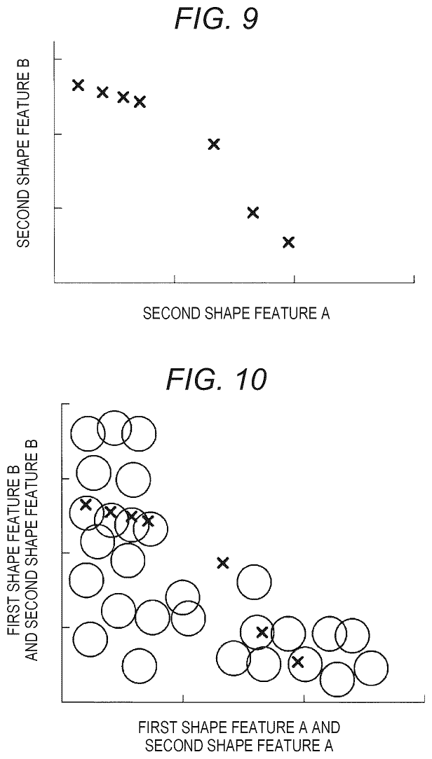

FIG. 9 is a graph illustrating an example of the second shape feature. FIG. 9 illustrates an example in which two types of second shape features, that is, a second shape feature A and a second shape feature B, are acquired, and the second shape feature is shown by a graph in which a horizontal axis represents the second shape feature A and a vertical axis represents the second shape feature B. The first shape feature A and the second shape feature A are the same type of feature, and the first shape feature B and the second shape feature B are the same type of feature. FIG. 9 illustrates the second shape feature calculated based on the predicted shape after one processing step as a cross mark on the graph. A plurality of second shape features of a plurality of types are calculated based on the predicted shape after each processing step obtained through the shape simulation. The calculator 11 stores the second shape features acquired for the predicted shapes after the plurality of processing steps in the storage 13. Further, the information processing apparatus 1 calculates the second shape features for each of the plurality of layers in the predicted shape.

Next, the information processing apparatus 1 calculates reliability of the predicted shape of the substrate at a stage when substrate processing is performed according to each processing step in the any recipe (S5). In S5, the calculator 11 compares a plurality of second shape features calculated based on the predicted shape after each processing step obtained through the shape simulation with the first shape feature. More specifically, the calculator 11 calculates the reliability by dividing the number of second shape features in the allowable range for the first shape feature among the plurality of second shape features obtained for each processing step by the number of second shape features obtained for each processing step.

FIG. 10 is a graph illustrating an example of a comparison result between the second shape feature and the allowable range for the first shape feature. The graph is illustrated in which a horizontal axis represents the first shape feature A and the second shape feature A, and a vertical axis represents the first shape feature B and the second shape feature B. In FIG. 10, each second shape feature is indicated by a cross mark on the graph, and the allowable range for each first shape feature is indicated by a white circle. The second shape feature overlapping the allowable range for the first shape feature on the graph is within the allowable range for the first shape feature.

The calculator 11 calculates the reliability of the predicted shape by the following formula: reliability=(number of second shape features in allowable range for first shape feature among plurality of second shape features obtained for each processing step)/(number of second shape features obtained for each processing step). As is clear from the reliability formula, a minimum value that the reliability can take is 0, and a maximum value is 1. In the example shown in FIG. 10, six second shape features among seven second shape features are within the allowable range for the first shape feature, and thus the reliability is 6/7. The calculator 11 calculates the reliability of the predicted shape for each of the plurality of processing steps. The calculator 11 stores the calculated reliability of the predicted shape in the storage 13. Further, the information processing apparatus 1 calculates the reliability of the predicted shape for each of the plurality of layers in the predicted shape.

As the reliability of the predicted shape increases, the predicted shape obtained through the shape simulation is closer to the predicted shape obtained through the shape simulation under conditions of the predetermined initial shape and the predetermined recipe. In the shape simulation under conditions of the predetermined initial shape and the predetermined recipe, the predicted shape is accurate. That is, as the reliability of the predicted shape increases, the predicted shape becomes closer to the accurate predicted shape obtained under the predetermined conditions. Therefore, as the reliability of the predicted shape increases, a more accurate predicted shape can be expected. Therefore, the reliability of the predicted shape is an index indicating how accurately the predicted shape after each processing step predicts the substrate shape.

Next, the information processing apparatus 1 outputs a relationship between the processing steps in the recipe related to the shape simulation and the reliability of the predicted shape (S6). In S6, the calculator 11 correlates each processing step with the reliability of the predicted shape after each processing step and displays an image that includes each processing step and the reliability of the predicted shape on the display unit 16.

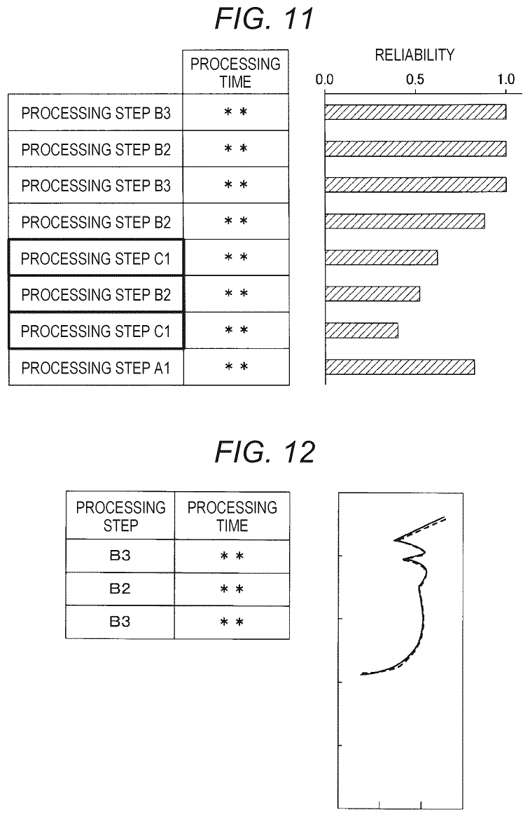

FIG. 11 is a schematic diagram illustrating an output example of the processing step and the reliability of the predicted shape. A name of each processing step in the recipe related to the shape simulation is displayed. An order in which the processing steps are arranged indicates the order in which the substrate processing according to the processing steps is executed. For example, the substrate processing according to each processing step is executed sequentially from top to bottom. Each processing step is associated with a processing time.

Each processing step is associated with the reliability of the predicted shape. In FIG. 11, the reliability is shown by a bar graph. A length of the bar graph corresponds to a value of the reliability. By showing the reliability of the predicted shape in the bar graph, the user who views the image can easily check a magnitude of the reliability of the predicted shape. A numerical value of the reliability may be displayed. At this time, the calculator 11 highlights and displays a processing step where the reliability of the predicted shape is low. For example, the calculator 11 highlights and displays a processing step where the reliability is less than a predetermined threshold value such as 0.6. In FIG. 11, the processing step having low reliability of the predicted shape is displayed in a highlighted manner by using a bold line for a frame of the name of the processing step. For example, highlighting may be performed by a method such as changing a color of the name of the processing step, changing a color inside the frame of the name of the processing step, adding a shape such as an arrow to the processing step, or blinking the name of the processing step.

FIG. 12 is a schematic diagram illustrating an example of a comparison between a predicted shape having high reliability and a substrate shape obtained through actual substrate processing. Processing steps executed sequentially are listed, and a graph showing a relationship between a position of a hole formed in the substrate in a depth direction and a width of the hole is shown. As shown in the list of processing steps, an example at a stage when a processing step B3, a processing step B2, and the processing step B3 are performed sequentially is shown. A horizontal axis of the graph represents the width of the hole. A vertical axis of the graph represents the depth of the hole, and the depth of the hole increases towards the bottom. In the graph, the predicted shape at this stage is shown by a solid line, and the substrate shape obtained through actual substrate processing is shown by a broken line. The actual shape is obtained through an experiment in which substrate processing is actually executed according to the processing steps. The reliability of the predicted shape at this stage is high, and the predicted shape substantially coincides with the actual shape.

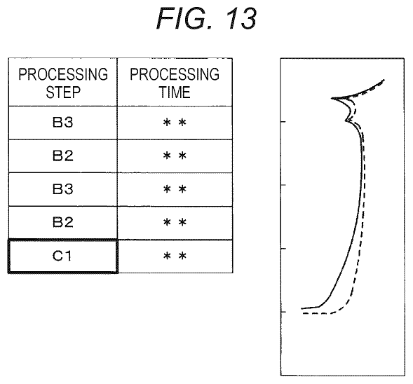

FIG. 13 is a schematic diagram illustrating an example of a comparison between a predicted shape having low reliability and the substrate shape obtained through actual substrate processing. Processing steps executed sequentially are listed, and a graph showing a relationship between a position of a hole formed in the substrate in a depth direction and a width of the hole is shown. As shown in the list of processing steps, an example at a stage when the processing step B3, the processing step B2, the processing step B3, the processing step B2, and a processing step C1 are performed sequentially is shown. In the graph, the predicted shape at this stage is shown by a solid line, and the substrate shape obtained through actual substrate processing is shown by a broken line. The reliability of the predicted shape at this stage is low. An error between the predicted shape and the actual shape is large, and the predicted shape is inaccurate. The error increases since the processing step C1 where the reliability of the predicted shape is low is performed. FIG. 13 illustrates an example in which the processing step C1 where the reliability of the predicted shape is low is displayed in a highlighted manner.

The information processing apparatus 1 outputs the relationship between the processing step and the reliability of the predicted shape for each of the plurality of layers in the predicted shape. For example, the calculator 11 displays the relationship between the processing step and the reliability of the predicted shape on the display unit 16 while switching between layers. For example, the user operates the operation unit 15 to input a switching instruction, and the calculator 11 switches the display according to the received instruction. Reliability of each layer in the predicted shape becomes clear.

After S6 is ended, the information processing apparatus 1 ends the processing of analyzing the reliability of the predicted shape. The information processing apparatus 1 performs the processing of S1 to S6 as appropriate. For example, the information processing apparatus 1 executes processing of S1 to S6 each time the shape simulation is performed. The information processing apparatus 1 may receive a plurality of recipes and execute the processing of S1 to S6 for each recipe.

As described in detail above, in the embodiment, the information processing apparatus 1 acquires the first shape feature that characterizes the predicted shape based on the shape simulation performed under the predetermined conditions, and calculates the second shape feature that characterizes the predicted shape based on any shape simulation. The information processing apparatus 1 compares the second shape feature and the first shape feature to calculate the reliability of the predicted shape by any shape simulation, and outputs the relationship between the processing step and the reliability. The reliability of the predicted shape obtained by the shape simulation is clearly shown, and the user can know how accurate the obtained predicted shape is.

The reliability of the predicted shape is clearly shown for each step, and the user can know how accurate the predicted shape after each processing step is. The reliability of the final predicted shape obtained by the shape simulation is also clearly shown, and the user can know the reliability of the predicted shape obtained by the shape simulation based on any recipe. For example, the user may calculate the reliability of the predicted shape for a plurality of recipes, and may adopt a recipe where the reliability of the predicted shape is high as a recipe used in actual substrate processing.

The shape simulation can also be improved according to the reliability of the predicted shape. When the reliability of the predicted shape obtained based on a certain recipe is low, substrate processing according to the recipe is actually executed to acquire an actual shape of the substrate. The simulation model 132 is adjusted such that the predicted shape coincides with the actual substrate shape. Accordingly, the simulation model 132 can be improved such that the substrate shape can be more accurately predicted, and accuracy of the shape simulation can be improved.

In the embodiment, dry etching on a semiconductor wafer is mainly described as an example of the substrate processing, and the substrate processing may be any other process as long as the substrate shape changes due to the processing. For example, the substrate processing may be film formation such as chemical vapor deposition (CVD). The substrate to be subjected to the substrate processing may be a substrate other than a semiconductor wafer, such as a glass substrate or a mask for exposure.

The invention is not limited to contents of the above-described embodiment, and various modifications may be made within the scope described in the following claims. In other words, embodiments obtained by combining technical means appropriately changed within the scope indicated in the claims are also included in the technical scope of the invention. The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

The features described in each embodiment can be combined with each other. In addition, the independent and dependent claims set forth in the claims can be combined with each other in any and all combinations, regardless of the reciting format. Furthermore, the claims use a format of describing claims that recite two or more other claims (multi-claim format). However, the present disclosure is not limited thereto. The claims may also be described using a format of multi-claims reciting at least one multi-claim (multi-multi claims).

1. A non-transitory computer-readable storage medium storing a computer program that, when executed by a computer, causes the computer to execute a method comprising:
acquiring a first shape feature that characterizes a predicted shape obtained by predicting a shape of a processed substrate using a model for simulating processing on a substrate having a predetermined shape according to a predetermined recipe including a predetermined plurality of processing steps;
simulating, using the model, processing according to any recipe on a substrate having any shape, and calculating a second shape feature that characterizes a predicted shape of the substrate at a stage when processing according to each processing step in the any recipe is performed;
comparing the second shape feature with the first shape feature to calculate reliability of the predicted shape of the substrate at the stage when the processing according to each processing step in the any recipe is performed; and
outputting a relationship between the reliability and each processing step in the any recipe.

2. The non-transitory computer-readable storage medium according to claim 1, wherein
the first shape feature and the second shape feature are calculated using a size or an angle of a specific portion in the predicted shape of the substrate, or a Hu moment or an elliptic Fourier descriptor obtained by analyzing the predicted shape.

3. The non-transitory computer-readable storage medium according to claim 1, wherein the method further comprises:
determining an allowable range where a plurality of the first shape features obtained for the plurality of processing steps in the predetermined recipe are contained; and
calculating, as the reliability related to each processing step in the any recipe, a value obtained by dividing the number of second shape features in the allowable range among a plurality of the second shape features calculated for the respective processing steps in the any recipe by the number of the plurality of second shape features.

4. The non-transitory computer-readable storage medium according to claim 1, wherein the method further comprises:
calculating the first shape feature, the second shape feature, and the reliability for each of a plurality of layers in the substrate.

5. The non-transitory computer-readable storage medium according to claim 1, wherein the method further comprises:
displaying a list of the plurality of processing steps and highlighting a processing step where the reliability is low.

6. The non-transitory computer-readable storage medium according to claim 1, wherein the method further comprises:
when the reliability of the predicted shape for at least one processing step is below a predetermined threshold, causing actual substrate processing to be performed on a physical substrate according to the any recipe to obtain an actual shape of the processed physical substrate, acquiring the actual shape, and adjusting the model such that the predicted shape matches the actual shape.

7. The non-transitory computer-readable storage medium according to claim 6, wherein the model includes a plurality of parameters related to processing conditions, and
adjusting the model comprises adjusting the plurality of parameters such that the predicted shape coincides with the actual shape.

8. The non-transitory computer-readable storage medium according to claim 6, wherein the processing on the substrate is dry etching or film formation.

9. The non-transitory computer-readable storage medium according to claim 6, wherein outputting the relationship between the reliability and each processing step in the any recipe comprises displaying a bar graph corresponding to a value of the reliability for each processing step.

10. The non-transitory computer-readable storage medium according to claim 6, wherein the method further comprises outputting the relationship between the reliability and each processing step in the any recipe for each of a plurality of layers in the substrate.

11. An information processing method comprising:
acquiring a first shape feature that characterizes a predicted shape obtained by predicting a shape of a processed substrate using a model for simulating processing on a substrate having a predetermined shape according to a predetermined recipe including a predetermined plurality of processing steps,
simulating, using the model, processing according to any recipe on a substrate having any shape, and calculating a second shape feature that characterizes a predicted shape of the substrate at a stage when processing according to each processing step in the any recipe is performed,
comparing the second shape feature with the first shape feature to calculate reliability of the predicted shape of the substrate at the stage when the processing according to each processing step in the any recipe is performed, and
outputting a relationship between the reliability and each processing step in the any recipe.

12. The information processing method according to claim 11, further comprising:
when the reliability of the predicted shape for at least one processing step is below a predetermined threshold, performing actual substrate processing on a physical semiconductor substrate according to the any recipe to obtain an actual shape of the processed physical semiconductor substrate, acquiring the actual shape, and adjusting the model such that the predicted shape matches the actual shape.

13. The information processing method according to claim 12, further comprising:
determining an allowable range where a plurality of the first shape features obtained for the plurality of processing steps in the predetermined recipe are contained; and
calculating, as the reliability related to each processing step in the any recipe, a value obtained by dividing the number of second shape features in the allowable range among a plurality of the second shape features calculated for the respective processing steps in the any recipe by the number of the plurality of second shape features.

14. The information processing method according to claim 12, further comprising:
calculating the first shape feature, the second shape feature, and the reliability for each of a plurality of layers in the substrate.

15. The information processing method according to claim 12, further comprising:
displaying a list of the plurality of processing steps and highlighting a processing step where the reliability is low.

16. The information processing method according to claim 12, wherein the model includes a plurality of parameters related to processing conditions, and adjusting the model comprises adjusting the plurality of parameters such that the predicted shape coincides with the actual shape.

17. The information processing method according to claim 12, wherein outputting the relationship between the reliability and each processing step in the any recipe comprises displaying a bar graph corresponding to a value of the reliability for each processing step.

18. An information processing apparatus comprising:
circuitry configured to:
acquire a first shape feature that characterizes a predicted shape obtained by predicting a shape of a processed substrate using a model for simulating processing on the substrate having a predetermined shape according to a predetermined recipe including a predetermined plurality of processing steps,
simulate, using the model, processing according to any recipe on a substrate having any shape, and calculates a second shape feature that characterizes a predicted shape of the substrate at a stage when processing according to each processing step in the any recipe is performed,
compare the second shape feature with the first shape feature to calculate reliability of the predicted shape of the substrate at the stage when the processing according to each processing step in the any recipe is performed, and
output a relationship between the reliability and each processing step in the any recipe.

19. The information processing apparatus according to claim 18, wherein the circuitry is further configured to:
when the reliability of the predicted shape for at least one processing step is below a predetermined threshold, cause actual substrate processing to be performed on a physical semiconductor substrate according to the any recipe to obtain an actual shape of the processed physical semiconductor substrate, acquire the actual shape, and adjust the model such that the predicted shape matches the actual shape.

20. The information processing apparatus according to claim 18, wherein the circuitry is further configured to:
determine an allowable range where a plurality of the first shape features obtained for the plurality of processing steps in the predetermined recipe are contained; and
calculate, as the reliability related to each processing step in the any recipe, a value obtained by dividing the number of second shape features in the allowable range among a plurality of the second shape features calculated for the respective processing steps in the any recipe by the number of the plurality of second shape features.
